(19) United States
(12) Patent Application Publication
(10) Pub. No.: US 2013/0332872 A1
(43) Pub. Date: Dec. 12, 2013

(54) SYSTEM AND METHOD FOR DRAG HOVER DROP FUNCTIONALITY

(71) Applicant: EVERYTHINK Ltd., Tel Aviv (IL)

(72) Inventor: Yair Yeshayahu GRINBERG, Ramat Gan (IL)

(21) Appl. No.: 13/914,658

(22) Filed: Jun. 11, 2013

Related U.S. Application Data
(60) Provisional application No. 61/657,906, filed on Jun. 11, 2012.

(51) Int. Cl. G06F 3/0486

(52) U.S. Cl. CPC G06F 3/0486
USPC 715/769

(57) ABSTRACT

A method implementable on a computing device for transferring application data, including enabling a user to drag at least one data object out of a source full-screen application and enabling the user to drop said at least one data object into a landing site in a target full-screen application.

### CROSS-REFERENCE TO RELATED APPLICATIONS

This application claims benefit from U.S. Provisional Patent Applications No. 61/657,906, filed Jun. 11, 2012 which is hereby incorporated in its entirety by reference.

### FIELD OF THE INVENTION

The present invention relates to operating systems for mobile computing devices in general and to moving data between full screen applications on such devices in particular.

### BACKGROUND OF THE INVENTION

Mobile computing devices, such as personal data assistants (PDAs), tablets and smartphones, are known in the art. As technology progresses, the processing power of such devices has increased such that for many applications such devices are now viable alternatives to more conventional computing platforms, such as personal computers and notebooks. However, mobile devices are still constrained by their physical form; the size of their display screens is limited by the size of the devices themselves, and the display screen must also compete with a data input mechanism for the same limited amount of space.

A variety of different approaches have been adopted to address these issues. Some devices use a scaled down version of operating systems originally designed for desktop computers. Some mobile devices use “flip-top” or “slider” mechanisms that open to effectively expand the usable space of the device when in active use. Many devices are equipped with touchscreens to enable users to input data directly with a stylus or via keypad displays. Alternatively, some devices are equipped with miniature keyboards that facilitate full text entry.

The iOS mobile operating system, available for use with mobile devices from Apple, Inc. in the United States, maximizes screen usage with full-screen applications that when running, have use of the entire display area to the exclusion of other applications. Such full screen applications are typically controlled by direct manipulation using multi-touch gestures. User interaction with the operating system (OS) includes gestures such as swipe, tap, pinch, and reverse pinch, directly entered by the user via a touch-screen interface. The Android operating system, available from Android, Inc. in the United States, uses similar techniques to implement full-screen applications.

### SUMMARY OF THE PRESENT INVENTION

There is provided in accordance with a preferred embodiment of the present invention, a method implementable on a computing device for transferring application data. The method includes enabling a user to drag at least one data object out of a source full-screen application. The method also includes enabling the user to drop the at least one data object into a landing site in a target full-screen application.

Moreover, in accordance with a preferred embodiment of the present invention, the selection is an indicating gesture on the data object within the source full-screen application.

Further, in accordance with a preferred embodiment of the present invention, the computing device is a mobile device comprising a touch screen.

Still further, in accordance with a preferred embodiment of the present invention, the computing device includes a user interface enabling direct manipulation.

Additionally, in accordance with a preferred embodiment of the present invention, the first enabling includes comprises zooming out of the source full-screen application to a navigation state.

Moreover, in accordance with a preferred embodiment of the present invention, the second enabling includes zooming the target application into a full-screen mode in response to the user hovering over a visual representation of the at least one data object over a visual representation of the target application in the navigation state.

Further, in accordance with a preferred embodiment of the present invention, the method also includes identifying a need to continue hovering over a visual representation of the at least one data object.

Still further, in accordance with a preferred embodiment of the present invention, the method also includes enabling the user to browse for a landing site after the identifying.

Additionally, in accordance with a preferred embodiment of the present invention, the method also includes the target application activating a functionality implied by the landing site.

Moreover, in accordance with a preferred embodiment of the present invention, the second enabling includes transferring the at least one data object to a specific context within the target application.

Further, in accordance with a preferred embodiment of the present invention, the transferring includes assisting the user to navigate through one or more target applications until the proper context is reached.

There is provided in accordance with a preferred embodiment of the present invention, a method implementable on a computing device for transferring application data. The method includes receiving a selection by a user of at least one data object in a source full-screen application; enabling the user to drag the at least one data object out of the source full-screen application and enabling the user to select a target full-screen application by hovering the at least one data object over the target full-screen application. The method also includes enabling the user to hover over the at least one data object over a landing site in the target full-screen application and implanting the selected at least one data entity in the target full-screen application.

There is provided in accordance with a preferred embodiment of the present invention, a method implementable on a computing device for transferring application data. The method includes receiving a selection by a user of at least one data object in a source full-screen application; enabling selection of a target full-screen application by the user; enabling selection by the user of a landing site in the target full-screen application and implanting the selected at least one data entity in the target full-screen application in accordance with functionality determined by the landing site.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an a process flow diagram illustrating a novel “drag, hover and drop” (DHD) method for transferring data between two full screen applications; and

FIGS. 2-6 are process flow diagrams illustrating additional details of the steps of the method of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that while full-screen applications may optimize the user experience for users of a given such application, there may be drawbacks to the technique as currently implemented in iOS and Android. For example, since by definition, two such applications may not be concurrently viewable by the user, there may be no mechanism for smoothly transferring data between two full-screen applications via existing user interfaces, such as direct manipulation. An object may not be simply “dragged” and “dropped” from a source application to target application, because the two applications may not be simultaneously open on the display screen. Furthermore, when using existing methods for transferring data, there is no mechanism to simultaneously set the proper context in the source and target applications. For example, when transferring a specific phone number from a contact list application to scheduler application, current methods may not facilitate associating the phone number with a specific desired date and time in the scheduler application.

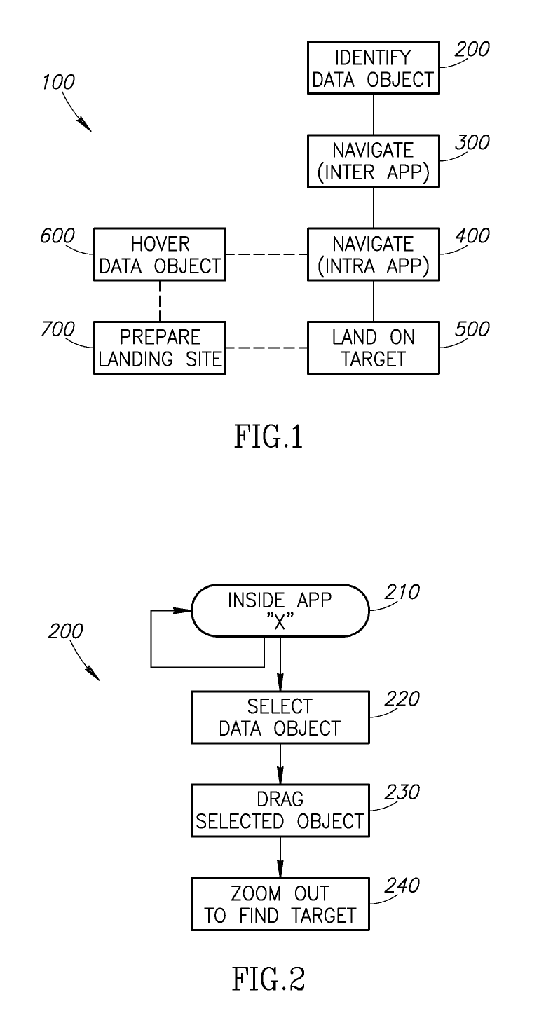

Reference is now made to FIG. 1 which illustrates a process flow diagram for a novel “drag, hover and drop” (DHD) method 100 for transferring data between two full screen applications. It will be appreciated that method 100 may be implemented for an operating system using direct manipulation. It will also be appreciated, however, that method 100 may also be implemented for any other user interface suitable for full-screen applications. Accordingly, while an exemplary process 100 as described hereinbelow may be described within the context of a direct manipulation user interface, it will be appreciated that other user interfaces may be included in the present invention as well.

A data object in an active application may be identified (step 200) for transfer to another application. The user may then easily navigate (step 300) to a target application with easy-to-use gestures. The user may similarly navigate (step 400) within the target application.

As will be discussed hereinbelow, while step 400 may be executed, when the user hesitates during the process, the data being transferred may appear to “hover” (step 600) in the target application, enabling the user to pause the process without losing the “dragged” information in order to manually prepare (step 700) an appropriate “drop zone”. The data may then be “landed” (step 500) to complete the transfer process.

Reference is now made to FIG. 2 which illustrates the process flow of step 200 from FIG. 1 in greater detail. The process may begin with a user inside (step 210) a given DHD enabled application “X”. The user may select (step 220) a data object for transfer. Such selection may be via any of the methods for known in the art, such as, for example, pressing down on the data object for longer than a threshold length of time. It will be appreciated that the present invention may also include the selection of multiple objects. However, in the interest of simplicity, the following description may refer to a single such selected object.

Once the user may begin to drag (step 230) the selected object within application “X”, the source application may then automatically “zoom out” (step 240) to a display of all potential target applications. In accordance with a preferred embodiment of the present invention, the indicating gesture for zooming out may also be user configurable, such that a user may select a gesture that may trigger a zoom out. Step 240 may also include a visual representation of the selected data entity as an icon or one or more other known type of symbol and/or character.

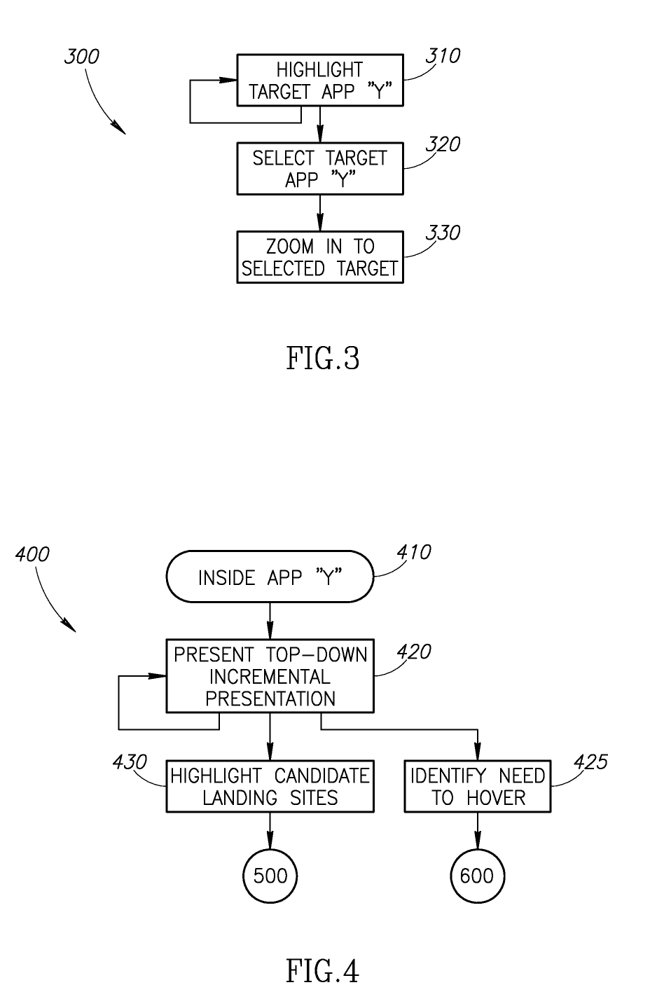

Reference is now made to FIG. 3 which illustrates the process flow of step 300 from FIG. 1 in greater detail. After completing step 200, the device may display the visual representation of the selected data object among the icons representing the available applications on the device. Candidate target applications for the selected data entity may be identified and highlighted (step 310) as per known methods, such as, for example, the target application may be identified by the visual proximity of the data icon to the relevant application icon. A given target application “Y” may thus be selected (step 320) as per such known methods. For example, the selection may be effected by a timeout while the application is highlighted as per step 310, or any other known method of application selection. Once target application “Y” is selected, control may “zoom in” (step 330) to continue the process.

Reference is now made to FIG. 4 which illustrates the process flow of step 400 from FIG. 1 in greater detail. After completing step 300, the device may activate (step 410) target application “Y”. It will be appreciated that target application “Y” may be a DHD enabled application. Application “Y” may attempt to automatically set the desired context for copying the data. For example, if as described hereinabove the copied data is a phone number from a contact list application, Application “Y” may open up an appointment for a predicted date and time to associate with the phone number.

If the automatic context identification is not successful, application “Y” may present (step 420) a top-down incremental presentation of candidate landing sites for selection by the user. Such presentation may use known methods for user interaction. For example, the application may “drill down” to different levels of data representation with application “Y” based on visual proximity and timeouts. In such manner, the user may “browse” application “Y” while searching for a suitable landing site for the selected entity. In accordance with an alternative preferred embodiment of the present invention, application “Y” may be configured as per user preferences regarding a desired starting point for said top-down incremental presentation.

Irregular movements while dragging the selected object and/or hesitating in an unused portion of the screen may identify (step 425) a need to “hover”. As will be discussed hereinbelow, while hovering, the selected entity may continue to “hover” as a visual representation while the user may manually browse for a landing site to select. Otherwise, candidate landing sites may be highlighted (step 430) for selection as per known methods.

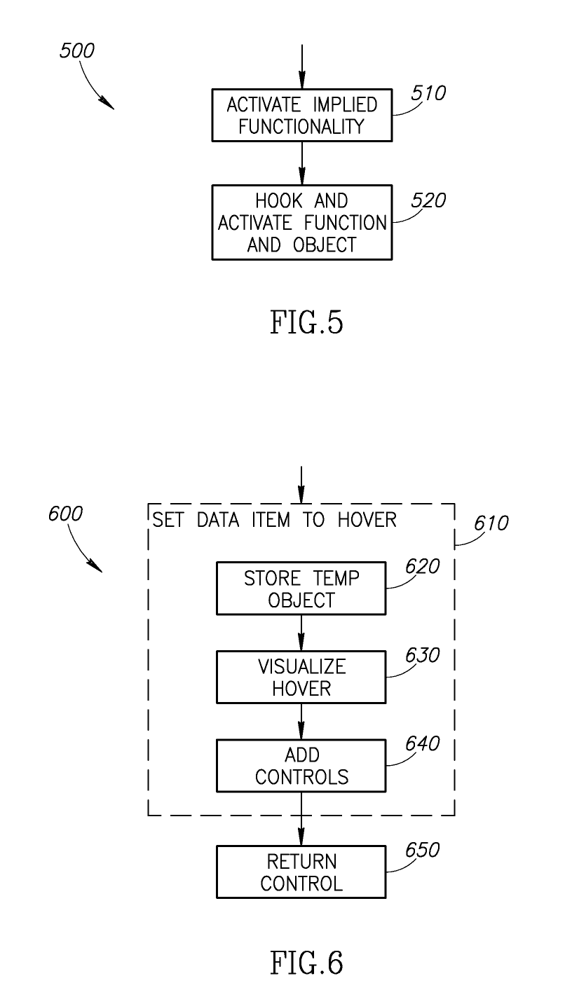

Reference is now made to FIG. 5 which illustrates the process flow of step 500 from FIG. 1 in greater detail. Once a landing command may be received from the user, target application “Y” may activate (step 510) the functionality implied by the selected landing site. For example, if target application “Y” is a scheduling client and the selected data object was a phone number from a contact list, a new appointment may be generated. It will be appreciated, that the present invention may also support updating an existing appointment.

Application “Y” may then “hook” (step 520) the activated functionality and selected object together. For example, if as discussed hereinabove target application “Y” is a scheduling client and a new appointment was created, the phone number may be associated with the new appointment.

It will be appreciated that the selected and copied data object may represent more than a single field or piece of data; the data object may be significantly more complex than a mere string of textual data. For example, the selected data object may be an entire personal contact from a contact list application. Such a personal contact may, for example, include the contact's name, street address, email address, phone numbers, etc.

It will be appreciated that the entire contact object may be copied into the target application during step 500. For example, if a personal contact may be copied into a calendar appointment entry in a target application, it may represent not only the name of the person associated with the appointment; all of the contact details may also be viewed and used by the user. For example, the user may use the copied contact object to initiate a phone call to the contact.

Reference is now made to FIG. 6 which illustrates the process flow of step 600 from FIG. 1 in greater detail. Step 600 may set (step 610) the “hover” option by temporarily storing the selected data entity (step 620), providing a visual representation of the selected data entity “hovering” on the display (step 630), and providing (step 640) appropriate cancel and land controls that may be activated by known methods for user interface, such as, for example, direct manipulation. Such “hovering” may be represented by an iconic representation of the selected entity appearing to hover or shake above the display of target application “Y”.

Once the DhD process may conclude, either by a “successful landing” or by cancellation, manual control may be returned (step 650) to the underlying application, i.e. target application “Y”.

While hovering, after control may be passed to the underlying application to facilitate manual navigation by the user, the landing site may be prepared (step 700) to enable the user to manually browse through Application “Y” in order to complete the process of setting the drop zone prior to step 500.

It will therefore be appreciated that the present invention may several options for transferring contextual data between full screen applications. There may be “automatic behavior” support for automatically transferring the data to a specific context within a target application. There may be a “drill-down” option to assist a user to navigate through one or more target applications until the proper context is reached. There may also be support for maintaining the data in a hover state while enabling the user to manually navigate one or more target applications until the proper context is reached.

Applicants have realized that the present invention may also be useful on an intra-application basis as well. The disclosed hovering function may also enable a user to transfer data inside a single application without having to maintain a continuing “drag” of the data object. Therefore, in accordance with another preferred embodiment of the present invention, the present invention may also be implemented within the context of a single application, without necessitating step 300.

In accordance with a preferred embodiment of the present invention, movements within an intra-application implementation may be automated to reduce the amount of required user intervention. For example, dragging a given object may automatically trigger an associated likely “landing” on a different screen. Inter-application embodiments may also be configured with automated behavior when navigating between applications and/or determining likely landing sites.

It will be appreciated that the present invention provides a non-native environment solution for transferring data between full screen applications; such a solution may therefore not be contingent on modifications to existing mobile operating systems for implementation.

However, it will similarly be appreciated that the present invention may also be implemented within the context of a native environment solution via inclusion in an operating system that may support a suitable user interface such as direct manipulation. It may also be implemented via open APIs. It will similarly be appreciated, that the present invention may not be limited to mobile operating systems; DhD may be implemented for full-screen applications in any suitable environment.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, a cloud computing configuration, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method implementable on a computing device for transferring application data, the method comprising:
enabling a user to drag at least one data object out of a source full-screen application; and
enabling said user to drop said at least one data object into a landing site in a target full-screen application.

2. A method according to claim 1 and wherein said selection is an indicating gesture on said data object within said source full-screen application.

3. The method according to claim 1 and wherein said computing device is a mobile device comprising a touch screen.

4. The method according to claim 1 and wherein said computing device comprises a user interface enabling direct manipulation.

5. The method according to claim 1 wherein said first enabling comprises zooming out of said source full-screen application to a navigation state.

6. The method according to claim 1 and wherein said second enabling comprises zooming said target application into a full-screen mode in response to said user hovering over a visual representation of said at least one data object over a visual representation of said target application in said navigation state.

7. The method according to claim 6 and also comprising identifying a need to continue hovering over a visual representation of said at least one data object.

8. The method according to claim 7 and also comprising enabling the user to browse for a landing site after said identifying.

9. The method according to claim 1 and also comprising said target application activating a functionality implied by said landing site.

10. The method according to claim 1 and wherein said second enabling comprises transferring said at least one data object to a specific context within said target application.

11. The method according to claim 10 and wherein said transferring comprises assisting said user to navigate through one or more target applications until the proper context is reached.

12. A method implementable on a computing device for transferring application data, the method comprising:
receiving a selection by a user of at least one data object in a source full-screen application;
enabling said user to drag said at least one data object out of said source full-screen application;
enabling said user to select a target full-screen application by hovering over said at least one data object over said target full-screen application;
enabling said user to hover over said at least one data object over a landing site in said target full-screen application; and
implanting said selected at least one data entity in said target full-screen application.

13. A method implementable on a computing device for transferring application data, the method comprising:
receiving a selection by a user of at least one data object in a source full-screen application;
enabling selection of a target full-screen application by said user;
enabling selection by said user of a landing site in said target full-screen application; and
implanting said selected at least one data entity in said target full-screen application in accordance with functionality determined by said landing site.
